(19) United States
(12) Patent Application Publication
(10) Pub. No.: US 2006/0197705 A1
(43) Pub. Date: Sep. 7, 2006

(54) IMPROVED PLANAR INVERTED F-ANTENNA

(76) Inventors: Li-Sen Chen, Taoyuan Hsien (TW); Jie-Lin Tseng, Taoyuan Hsien (TW); Cheng-Jyu Jiang, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,252

(22) Filed: Dec. 21, 2005

(30) Foreign Application Priority Data
Feb. 25, 2005 (TW) 94202962

(51) Int. Cl. H01Q 1/38

(52) U.S. Cl. 343/700 MS; 343/702

(57) ABSTRACT

An improved planar inverted-F antenna (PIFA) is provided. The PIFA made with a bent metal sheet having a substantial four-side frame in sectional contour includes a feed sheet, a radiating sheet, a grounding sheet and a short lead. Wherein, a feed lead is protruded from the feed sheet, a grounding lead is protruded from the grounding sheet; the feed lead and the grounding lead are adjacent to each other, a bent flange extends outward from an end of the grounding sheet towards the direction of the radiating sheet and a fastener is disposed on the bent flange used for fixing the antenna onto an electronic device.

### CROSS-REFERENCE TO RELATED APPLICATION

This application claims the priority benefit of Taiwan application serial no. 94202962, filed on Feb. 25, 2005. All disclosure of the Taiwan application is incorporated herein by reference.

### BACKGROUND OF THE INVENTION

1. Field of Invention

The present invention relates to an antenna structure, and particularly to an improved planar inverted-F antenna (PIFA), which is firmly disposed in applicable electronic devices.

2. Description of the Related Art

Planar inverted-F antennas (PIFAs) have superior features, including low side-height, lightweight, larger range of bandwidth and stable range of bandwidth in whole. Therefore, PIFAs are in particular suitable for the electronic devices in wireless communication with personal base stations, such as mobile phones, Bluetooth® devices, other wireless devices with ISM (Industrial Scientific Medical) band, data communication terminals and other RF (radio frequency) devices.

FIG. 1 is a schematic 3-dimensional drawing of a conventional PIFA.

Referring to FIG. 1, a PIFA includes a radiating sheet 110, a grounding sheet 112, a printed circuit board (PCB) 101, a short lead 122 and an isolation structure 170. Wherein, the radiating sheet 110 is higher than the grounding sheet 112 and connected to a signal feed lead 121 which is electrically connected to an outer RF circuit. The short lead 122 is connected between the radiating sheet 110 and the grounding sheet 112. The isolation structure 170 is used for supporting the radiating sheet 110. Besides, the radiating sheet 110 contains a slit 115. In view of a short circuit, the slit 115, from an edge of the radiating sheet 110, stretches and extends on the radiating sheet 110, so that the radiating sheet 110 is consequently partitioned into two portions with two different lengths. In this way, the PIFA obtains two major resonating frequencies and individual operating bands.

FIG. 2 is a diagram of PIFA impedance characteristics in FIG. 1. Referring to FIG. 2, it is assumed that the conditions are ideal and a VSWR (Voltage Standing Wave Ratio) of 2.5:1 is taken as the criterion to define the operating bandwidth. If the center frequency f1 of a radiating sheet A is slightly lower than the desired band center (center of frequency band) f0 of the antenna and the center frequency f2 of a radiating sheet B is slightly higher than the desired band center f0, then an antenna combining the two sheets is preferred for getting a broader operating bandwidth. To implement the scheme, in the prior art, the antenna includes a design with the above-mentioned slit 115, so that the radiating sheet 110 is partitioned into two portions.

It is known, however, that the above-described PIFA has at least a serious problem, i.e., the PIFA will shake along with the printed circuit board (PCB) once the PCB thereof vibrates, which likely gives a negative impact on the desired frequency response characteristic. If the aforesaid antenna does not have any additional support to the isolation structure 170, the problem of shaking will be occurred. Besides, the impedance of the above-described conventional antenna is hard to be tuned unless the position or the shape of the slit 115 is redesigned.

U.S. Pat. No. 6,714,162 discloses a PIFA. Referring to FIG. 3, the PIFA includes a radiating sheet 11, a grounding sheet 12, a feed lead 13, a first feed lead element 13a, a second feed lead element 13b, a short lead 14, a first short element 14a, a second short element 14b and a short parasitic element 15.

The short parasitic element 15 has a first parasitic element edge 15a and a second parasitic element edge 15b. The first parasitic element edge 15a serves for connecting the short parasitic element 15 to the grounding sheet 12, while the second parasitic element edge 15b has a gap distance pg departing from the bottom of the radiating sheet 11. In addition, a short gap sg exits between the short parasitic element 15 and the short lead 14. The above-described short parasitic element 15 serves as a tuning component for controlling the higher resonance frequency of the radiating sheet 11, i.e. by modifying the dimensions of the short parasitic element 15, a desired PIFA impedance characteristic is obtained.

Each of the dimensions and angular separations of a PIFA affects the impedance thereof, which further directly affects the RF (radio frequency) performance at higher frequency. The proposed method disclosed in U.S. Pat. No. 6,714,162 is able to overcome the drawback described above, i.e. the hard-adjustment of PIFA impedance; nevertheless, the vibration problem still remains unsolved. Thus, how to make a PIFA more stable and firm has become a significant issue for the PIFA application in mobile communications.

### SUMMARY OF THE INVENTION

In view of the above described, an object of the present invention is to provide an improved planar inverted-F antenna (PIFA) with disposition of fasteners for solving the vibration problem in the prior art.

To achieve the above-mentioned object, the disclosed antenna of the present invention has a substantial four-side frame in sectional contour and mainly includes a feed sheet, a radiating sheet, a grounding sheet and a short lead. Wherein, the feed sheet and the grounding sheet have a protruding lead, respectively, and the two protruding leads are adjacent to each other. The grounding sheet has at least a protruding bent flange at one end. A fastener is disposed on the bent flange for fixing the PIFA onto a foundation of a specific device. Since all the dimensions and the angular separations of the PIFA in the present invention have less free-moving degrees, the overall impedance of the antenna is more robust to resist the harmful effect by the vibration of mobile communication device. Accordingly, more stable RF performance of the PIFA is achieved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic 3-dimensional drawing of a conventional PIFA.

FIG. 2 is a diagram explanatory of PIFA impedance characteristics in FIG. 1.

FIG. 3 is a schematic 3-dimensional drawing of another conventional PIFA.

FIG. 4 is a schematic 3-dimensional drawing of a PIFA in an embodiment of the present invention.

FIG. 5 is a schematic front view of the PIFA in FIG. 4.

FIG. 6 is a schematic 3-dimensional drawing of a PIFA in another embodiment of the present invention.

FIG. 7 is a schematic 3-dimensional assembly drawing of a PIFA in an embodiment of the present invention.

FIG. 8 is a schematic 3-dimensional drawing of a PIFA in another embodiment of the present invention.

FIG. 9 is a Smith chart of the embodiment of the present invention.

FIG. 10 and FIG. 11 are the impedance characteristic diagrams inducted from the Smith chart of FIG. 9.

FIG. 12 is a PIFA detailed drawing with specification dimensions of the present invention.

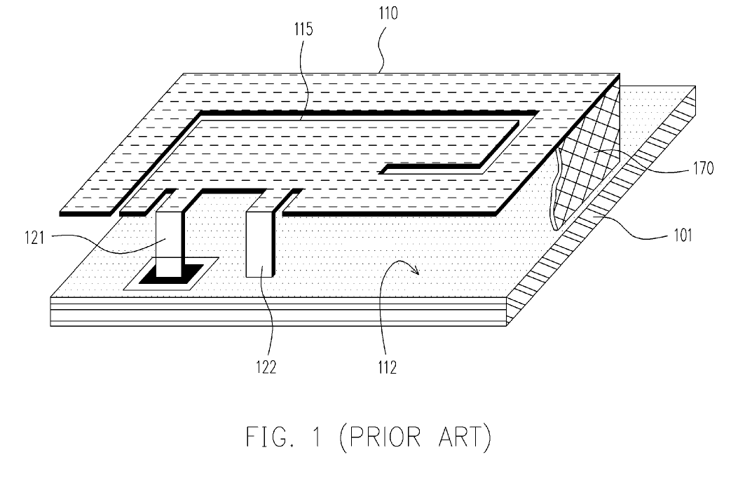

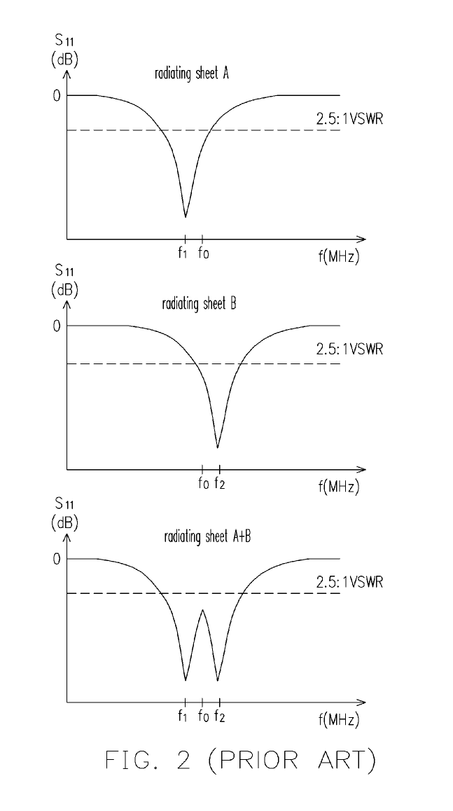

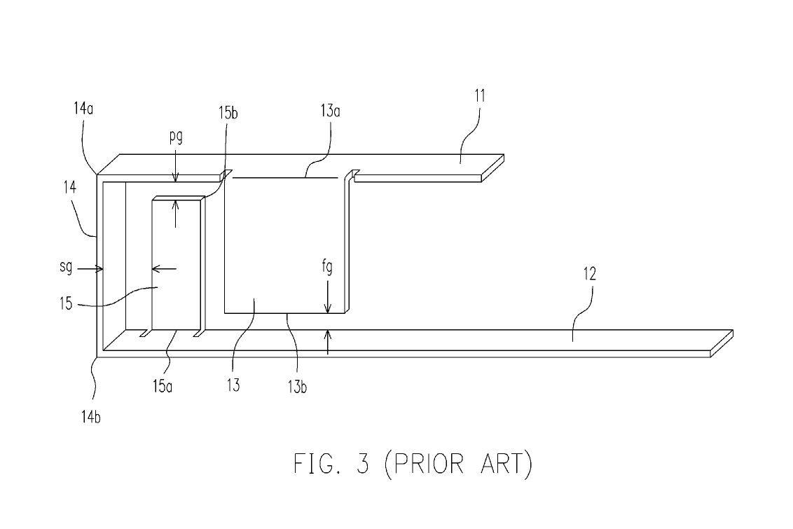

### DESCRIPTION OF THE EMBODIMENTS

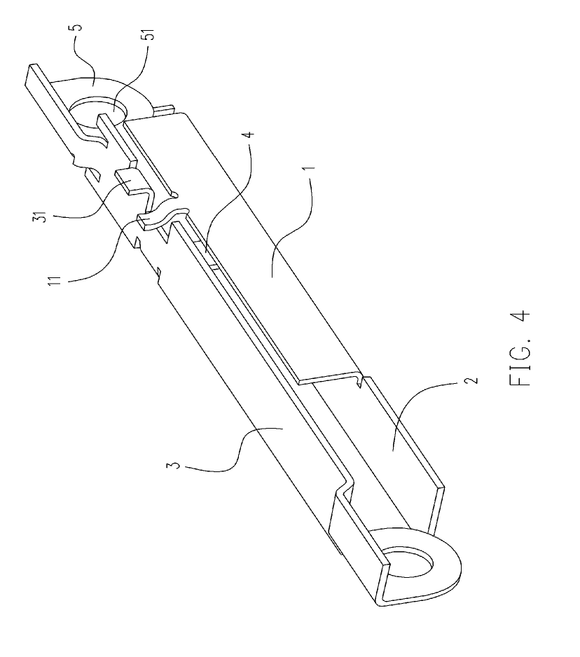

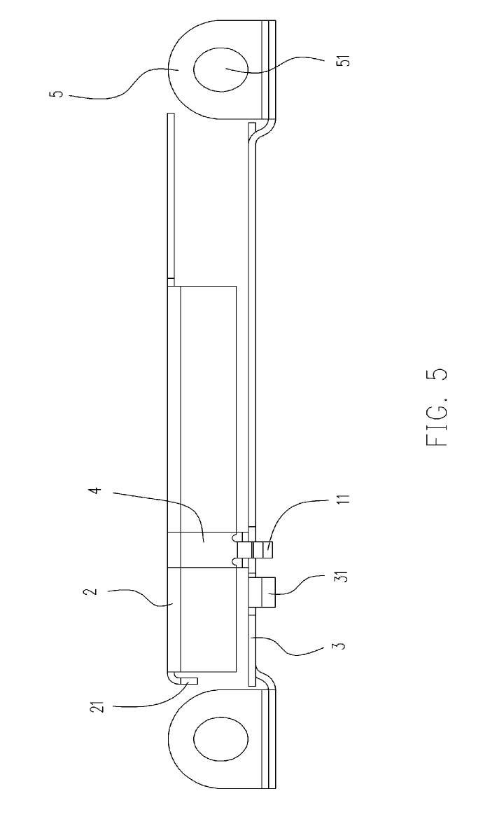

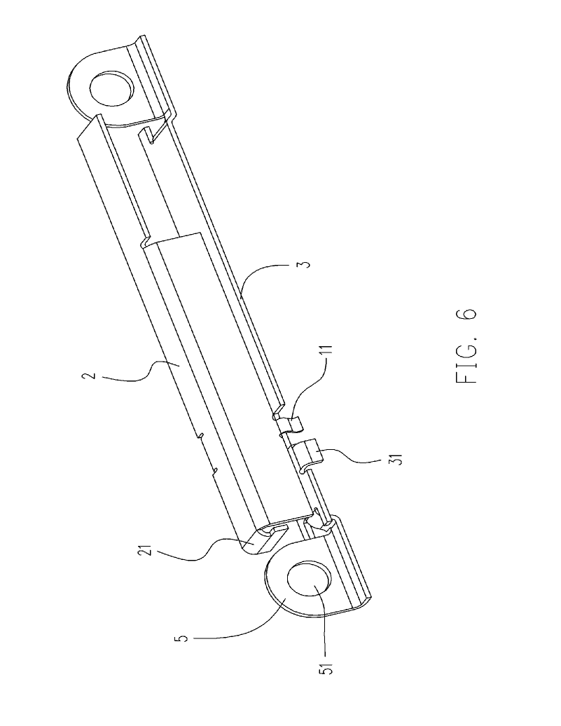

FIG. 4 is a schematic 3-dimensional drawing of a PIFA in an embodiment of the present invention and FIG. 5 is a schematic front view of the PIFA in FIG. 4. Referring to FIG. 4 and FIG. 5, an improved planar inverted-F antenna (PIFA) of the present invention is made by bending a metal sheet and mainly includes a feed sheet 1, a radiating sheet 2, a grounding sheet 3 and a short lead 4. Wherein, a feed lead 11 extends from the feed sheet 1, a grounding lead 31 extends from the grounding sheet 3, and the above-mentioned feed lead 11 and the grounding lead 31 are not in contact but adjacent to each other. Two bent flanges 5 are protruded from both ends of the grounding sheet 3, respectively. Two through holes 51 are disposed on each of the bent flanges 5, respectively. In addition, a hang tab 21 is disposed on the radiating sheet 2 for tuning the impedance of the antenna. Wherein, the length and the width of the feed sheet 1 are, for example, 19.60 mm and 3.20 mm, respectively; the length and the width of the radiating sheet 2 are, for example, 28.40 mm and 4.00 mm, respectively; the length and the width of the grounding sheet 3 are, for example, 28.60 mm and 4.00 mm, respectively. Besides, there may be a bent configuration as shown in FIG. 4 at the location near the grounding sheet 3 and the bent flanges 5. However, as shown in FIG. 6, which is a perspective view of a PIFA in another embodiment of the present invention, the above-mentioned bent configuration may be a flat configuration.

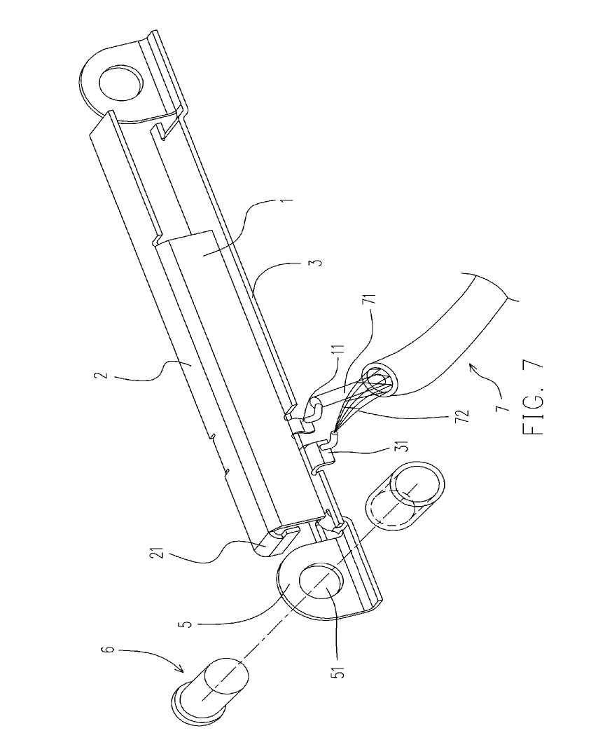

Referring to FIG. 7, it is a schematic 3-dimensional assembly drawing of a PIFA in an embodiment of the present invention. Referring to the figure, a coaxial cable 7 for communicating signals between a mobile communication device and an antenna comprises at least a core wire 71 and a metal shielding-braid 72. The core wire 71 is mainly used for signal transmission, while the metal shielding-braid 72 enclosing the core wire 71 is mainly used for preventing or reducing a mutual electromagnetic induction produced by the signal traveling along the core wire 71 and the external environment.

As the PIFA provided by the present invention is hooked up with the coaxial cable 7, the core wire 71 of the coaxial cable 7 is fixed with the feed lead 11 and the metal shielding-braid 72 is electrically connected to the grounding lead 31. Further, the fasteners 6 are fixed to the through holes 51 at the bent flanges 5 of both ends of the grounding sheet 3. In this way, the PIFA is firmly fixed on an electronic device (not shown in the figure) to increase the PIFA's dynamic stiffness without a vibration-isolating structure of the prior art. Wherein, the above-described fasteners 6 can be, for example, bolts, rivets, screws or other, commonly used, even elements.

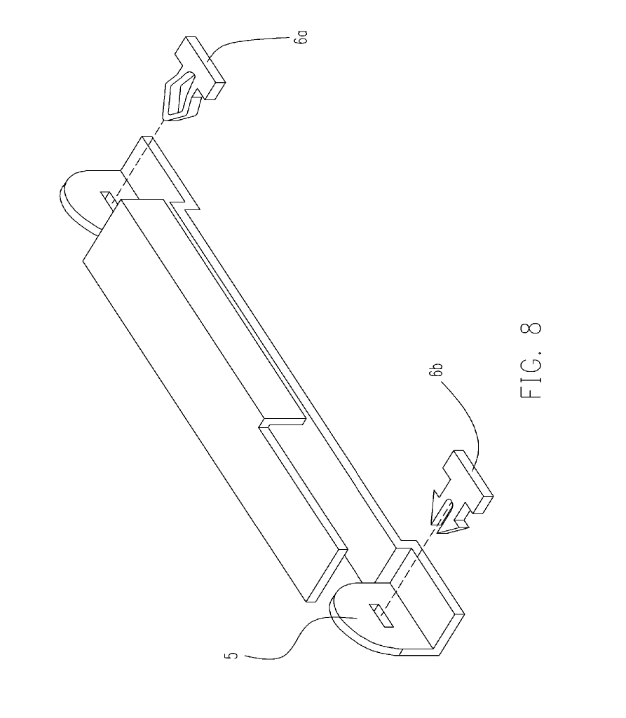

Referring to FIG. 8, it is a schematic 3-dimensional drawing of a PIFA in another embodiment of the present invention. Similarly to the structure for fixing the antenna on an electronic device in FIG. 7, instead of the fasteners 6, clip hooks or other buckles, such as two nylon panel rivets 6a, can be used. The nylon panel rivets 6a can be directly hooked on the electronic device so that to simplify the assembly procedure.

Furthermore, there are two methods for installing an RF PIFA used in wireless LAN (local area network) for a notebook computer. The first method is to dispose the PIFA directly on the circuit board of a notebook computer, while the second method is to dispose the PIFA on the metal-shielding layer of a notebook computer. The description and experiment of the embodiment hereafter uses the first method as an example. Nevertheless, those skilled in the art are able to make modifications for disposing a PIFA on a notebook computer by the above-mentioned second disposition method.

The fasteners 6 employed for fixing a PIFA on an electronic device in the preferred embodiment are made of conductive metal. Such metal fasteners 6 would partially contribute to the RF characteristics for the antenna to transmit high frequency signals. In other words, the metal fasteners 6 should be considered as a part of the PIFA. However, the present invention should not be limited to the disclosure of the preferred embodiment which uses the metal fasteners 6 as exemplary explanation. In fact, those skilled in the art are able to conceive that the fasters 6 can be alternatively made of an isolation material or other equivalent elements.

Since the fasteners 6 employed in the embodiment have a cylinder-like geometrical shape and no other auxiliary fastening devices are equipped, the fastening structure in the embodiment is designed with two bent flanges 5 stretching outwards from both ends of the grounding sheet 3 and towards the direction of the radiating sheet 2; and two metal fasteners 6 reside at the centers of the bent flanges 5. However, if an additional auxiliary fastening device has been disposed in a mobile communication device because of, but not limited to, a special design of a notebook computer case, only one bent flange 5 and one fastener 6 are required for firmly fixing the PIFA. In addition, a hang tab 21 residing on the radiating sheet 2 in the embodiment is for conveniently tuning the impedance of the PIFA. Therefore, it will be easy to those skilled in the art to appropriately modify the disclosed dimensions in the embodiment and the given place and/or shape of the hang tab 21 for a desired PIFA impedance characteristic.

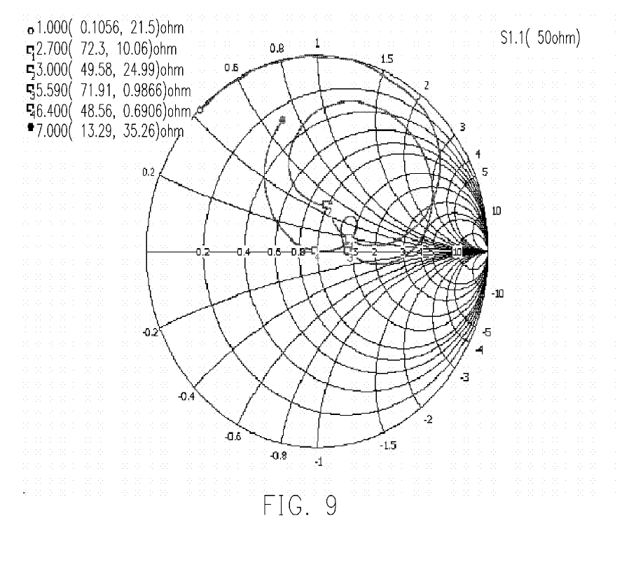

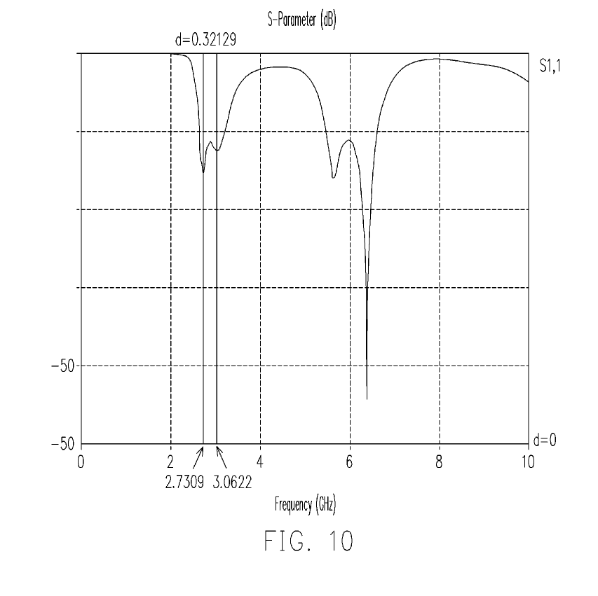

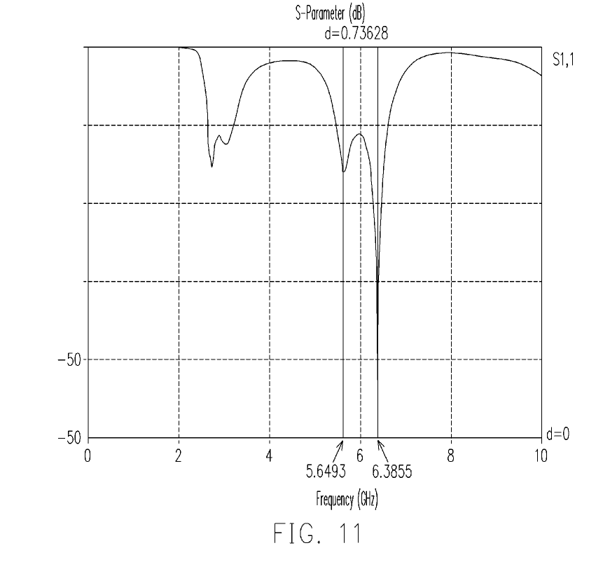

FIG. 9 is a Smith chart of the embodiment of the present invention, and FIG. 10 and FIG. 11 are the impedance characteristic diagrams inducted from the Smith chart of FIG. 9. Referring to FIGS. 9, 10 and 11, based on the electromagnetic principle, the closer the PIFA's impedance to the conductive wire impedance is, the lower the return loss of the conductive wire combined with the PIFA during transmitting RF signals has. In other words, a combination use of a conductive wire and a PIFA displays a more powerful capability for transmitting (both emitting and receiving) RF signals. Generally, the coaxial cable used in a notebook and connected to the PIFA has an approximate 50-ohm impedance specification. Therefore, if the impedance of the PIFA itself in the embodiment is closer to 50-ohm, the combination transmission of the conductive wire and of the PIFA has stronger RF signals. Similarly, for a stronger RF signal transmission by a PIFA, it can be seen that the impedance of the PIFA is likely closer to 50-ohm (an impedance of a standard coaxial cable).

According to the above-described condition, the Smith chart of the embodiment is as shown in FIG. 9. Further, four impedances corresponding to points 1, 2, 3 and 4 located near to the original point in the Smith chart (corresponding a 50-ohm impedance at the original point) are transferred to S1.1 charts of FIGS. 10 and 11. Wherein, in FIG. 10 the frequencies of the points 1 and 2 in FIG. 9 are indicated, while in FIG. 11 the frequencies of the points 3 and 4 in FIG. 9 are indicated. By viewing the impedances in FIGS. 10 and 11, whether the PIFA high-frequency performance of the embodiment is advanced or not can be concluded.

In FIGS. 10 and 11, the ordinate is S-parameter representing the return loss in unit of dB; the abscissa is frequency in unit of GHz. From the figures, it can be seen that the four points transferred from FIG. 9 are represented by four valley points with significantly less return losses, respectively. Assuming that the acceptable signal loss is 10 dB, then the two acceptable frequency bands in FIGS. 10 and 11 are 2.65-3.20 GHz with a bandwidth of 550 MHz and 5.47-6.62 GHz with a bandwidth of 1.15 GHz, respectively.

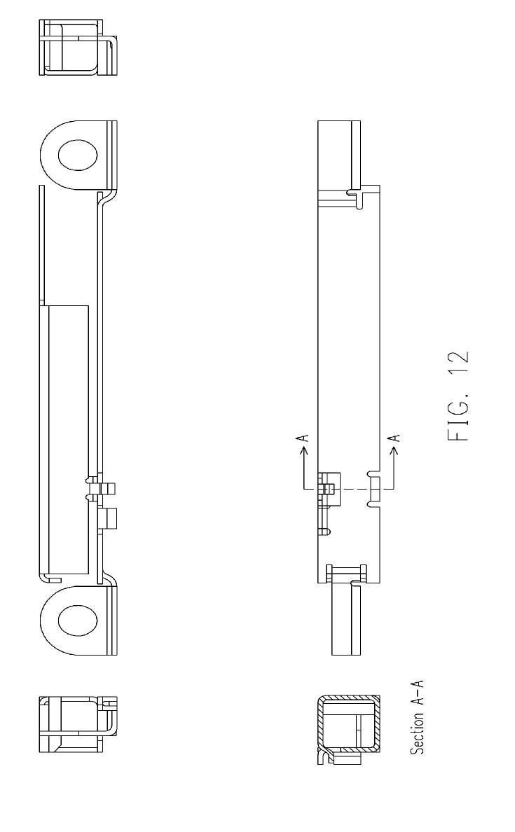

The ideal impedance performance shown in FIGS. 9, 10 and 11 are obtained by a simulation for the PIFA of the embodiment under air environment. In practice, the magnetic field produced by actuation of the electronic device after the PIFA is disposed into an electronic device would affect the PIFA to pull down signal transmission frequencies for about 10%. Therefore, the real operating bandwidths of a PIFA for 10 dB acceptance of return loss are accordingly modified to around 2.4-2.9 GHz for low frequencies and around 4.9-9.0 GHz for high frequencies, respectively. The PIFA of the present invention does not only meet the three IEEE standards of 802.11b/g (an operating bandwidth of 2.40-2.48 GHz required), 802.11a (an operating bandwidth of 4.90-5.85 GHz required), but also has a wider broad bandwidth than the ones required by the three specification standards IEEE 802.11a/b/g. To further illustrate the present invention, a detailed drawing with dimensions of a PIFA is shown in FIG. 12.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An improved planar inverted-F antenna (PIFA), having a feed sheet, a radiating sheet, a grounding sheet and a short lead connected between the radiating sheet and the grounding sheet, comprising:
a substantial four-side frame in sectional contour of the antenna;
two leads adjacent to each other and protruding from the feed sheet and the grounding sheet, respectively;
a bent flange extending outward from an end of the grounding sheet and bending towards the direction of the radiating sheet; and
a fastener residing on the bent flange for fixing the antenna onto an electronic device.

2. The improved PIFA as recited in claim 1, wherein the length and the width of the feed sheet are 19.60 mm and 3.20 mm, respectively.

3. The improved PIFA as recited in claim 1, wherein the length and the width of the grounding sheet are 28.60 mm and 4.00 mm, respectively.

4. The improved PIFA as recited in claim 1, wherein the fastener comprises a bolt, a screw or a rivet.

5. The improved PIFA as recited in claim 1, wherein the material of the fastener comprises conductive metal.

6. The improved PIFA as recited in claim 1, wherein the material of the fastener comprises isolation material.

7. The improved PIFA as recited in claim 1, wherein the fastener comprises a clip hook used for hooking the antenna onto a foundation of an electronic device.

8. The improved PIFA as recited in claim 1, wherein a hang tab is disposed on the radiating sheet used for tuning the impedance of the antenna.

9. The improved PIFA as recited in claim 1, wherein the length and the width of the radiating sheet are 28.40 mm and 4.00 mm, respectively.

10. The improved PIFA as recited in claim 1, wherein the foundation of the electronic device is a circuit board.

11. An improved planar inverted-F antenna (PIFA), having a feed sheet, a radiating sheet, a grounding sheet and a short lead connected between the radiating sheet and the grounding sheet, comprising:
a substantial four-side frame in sectional contour of the antenna;
two leads adjacent to each other and protruding from the feed sheet and the grounding sheet, respectively;
a bent flange extending outward from an end of the grounding sheet and bending towards the direction of the radiating sheet; and
a clip hook residing on the bent flange for fixing the antenna onto an electronic device.

12. The improved PIFA as recited in claim 11, wherein the material of the clip hook comprises isolation material.

13. The improved PIFA as recited in claim 12, wherein the clip hook comprises a buckle or a panel rivet.
